(19) United States
(12) Patent Application Publication
(10) Pub. No.: US 2006/0182513 A1
(43) Pub. Date: Aug. 17, 2006

(54) Fastener and method for using same

(76) Inventor: John Patrick Dortch, Charlotte, NC (US)

Correspondence Address: ADAMS EVANS P.A., 2180 TWO WACHOVIA CENTER, CHARLOTTE, NC, 28282, US

(21) Appl. No.: 11/058,567

(22) Filed: Feb. 15, 2005

(51) Int. Cl. F16B 21/00

(52) U.S. Cl. 411/338

(57) ABSTRACT

A fastening apparatus includes a reducer bolt and a complimentary female threaded element. The reducer bolt has an elongate threaded shank for inserting into the complementary female threaded element. The reducer bolt has a collar defining a threaded female opening. The collar is carried concentrically on the shank and has a diameter greater than the shank so that the collar contacts the complementary female threaded element to prevent further insertion of the shank into the female threaded element. A head is carried concentrically on the collar, and has an aperture communicating with the collar opening to receive a complementary male threaded member which mates with the threaded female opening of the collar. The head includes an engagement mechanism for receiving a complementary tool, such as a wrench, so that engagement between the shank and the complementary female threaded element is adjustable by turning the head with the tool.

### TECHNICAL FIELD AND BACKGROUND OF THE INVENTION

The invention relates to a fastening assembly for connecting objects together. The assembly includes a reducer bolt with male threading that engages the interior threading of a complementary female threaded piece. The reducer bolt has a head with an engagement mechanism that enables the reducer bolt to be tightened against and released from the female threaded piece with a basic tool. The reducer is particularly suited for connecting components of knockdown furniture assemblies.

Several furniture manufacturers in the United States produce furniture that can be disassembled for shipping and moving, and then reassembled at their final destination. Such knockdown furniture has typically used components having threaded inserts that accept bolts extending from another component of the furniture piece. For example, a T-nut and bolt has been used, as shown in FIG. 18. However, in large furniture pieces, and other heavy duty applications, pressure from the bolt tends to push the T-nut out of position. Also, the threading of the T-nut often wears out over time, and when it does the T-nut cannot be removed, which is problematic for knockdown furniture and other applications in which it is desirable to disassemble and reassemble the connected parts. The following invention was conceived to overcome these and other problems associated with the prior art.

### SUMMARY OF THE INVENTION

Therefore, it is an object of the present invention to provide a fastening assembly that can releasably connect two or more objects together.

It is another object of the invention to provide a fastening assembly that is particularly suited for use in a knockdown furniture assembly.

These and other objectives of the present invention are achieved by providing a fastener having an elongate threaded shank for being inserted into a complementary female threaded element, and a collar defining a threaded female opening. The collar is carried concentrically on the shank and has first and second ends. The first end is proximate the shank and has a diameter greater than the shank so that the collar contacts the complementary female threaded element and prevents further insertion of the shank into the female threaded element. A head is carried concentrically on the collar proximate the second end. The head has an aperture in communication with the collar opening for receiving a complementary male threaded member which mates with the threaded female opening of the collar. The head includes an engagement mechanism for receiving a complementary tool so that engagement between the shank and the complementary female threaded element is adjustable by turning the head with the tool.

According to one preferred embodiment of the invention, the engagement mechanism is a hexagonal indentation formed in the head, and the complementary tool is an Allen wrench.

According to another preferred embodiment of the invention, the engagement mechanism includes wrench flats formed in the head, and the complementary tool is a standard wrench.

According to yet another preferred embodiment of the invention, the complementary female threaded element includes a body defining a cavity having threads therein, and a cap having a diameter greater than the body.

According to yet another preferred embodiment of the invention, a fastening assembly for connecting a plurality of objects includes a first fastener having a body defining a cavity with threads therein, and a second fastener including an elongate threaded shank for inserting into the cavity of the first fastener to engage the threads of the cavity therein. The second fastener includes a collar defining a threaded female opening, and the collar is carried concentrically on the shank. The collar has first and second ends, with the first end being proximate the shank and having a diameter approximately equal to the body of the first fastener so that the collar contacts the body of the first fastener and prevents further insertion of the shank into the cavity of the first fastener. A head is carried concentrically on the collar proximate the second end of the collar. The head has an aperture in communication with the collar opening for receiving a complementary male threaded member for mating with the threaded female opening of the collar. The head includes an engagement mechanism for receiving a tool so that engagement between the first fastener and the second fastener is adjustable by turning the head of the second fastener with the tool.

According to yet another preferred embodiment of the invention, the first fastener includes a cap having a diameter greater than the body and at least one bore therein, and wherein the body is positioned within an object and a fastener is positioned through the bore(s) and into the object to maintain the body within the object.

According to yet another preferred embodiment of the invention, the first fastener and the second fastener are adapted for connecting components of a furniture piece.

According to yet another preferred embodiment of the invention, the second fastener is positioned within a first object, and the complementary male threaded member is positioned within a second object. As such, mating of the complementary male threaded member with the female threads of the second fastener connects the first and second objects.

According to yet another preferred embodiment of the invention, the first and second objects are components of a furniture piece.

A method for connecting a plurality of objects according to a preferred embodiment of the invention includes the steps of providing a first fastener having a body defining a cavity with threads therein, and positioning the first fastener within a first object. A second fastener is provided, which has an elongate threaded shank for inserting into the cavity of the first fastener and mating with the threads therein. A collar defining a threaded female opening is carried concentrically on the shank and has first and second ends. The first end of the collar is proximate the shank and has a diameter approximately equal to the body of the first fastener so that the collar contacts the body and prevents further insertion of the shank into the cavity of the first fastener. A head is carried concentrically on the collar proximate the second end and has an aperture in communication with the collar opening to receive a complementary male threaded member which mates with the threaded female opening of the collar. The head includes an engagement mechanism for receiving a tool. The shank is inserted into the cavity of the first fastener to engage the threads therein to connect the first fastener to the second fastener.

According to another preferred embodiment of the invention, the method includes the step of tightening the connection between the first fastener and the second fastener by turning the head of the second fastener clockwise with the tool.

According to yet another preferred embodiment of the invention, the method includes the step of releasing the connection between the first fastener and the second fastener by turning the head of the second fastener counterclockwise with the tool.

According to yet another preferred embodiment of the invention, the method includes the steps of positioning the complementary male threaded member in a second object, and inserting the complementary male threaded member into the threaded female opening of the second fastener to engage the second fastener and connect the first and second objects.

According to yet another preferred embodiment of the invention, the step of positioning the first fastener within a first object comprises positioning the first fastener within a first component of a furniture piece.

According to yet another preferred embodiment of the invention, the step of positioning the complementary male threaded member within a second object comprises positioning the male threaded member within a second component of the furniture piece, whereby the first and second components of the furniture piece are connected.

According to yet another preferred embodiment of the invention, the method includes the steps of positioning the second fastener within a second object, positioning the complementary male threaded member in a third object, and inserting the complementary male threaded member into the threaded female opening of the second fastener to engage the second fastener and connect the second and third objects.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an exploded perspective view of a fastening assembly according to a preferred embodiment of the invention;

FIG. 2 is a perspective view of the fastening assembly of FIG. 1;

FIG. 3 is another exploded perspective view of the fastening assembly of FIG. 1;

FIG. 4 is another perspective view of the fastening assembly of FIG. 1;

FIG. 5 is a side elevation of the fastening assembly of FIG. 1;

FIG. 5A is a partial cross sectional view of the fastenting assembly of FIG. 1, shown along line 5A of FIG. 5.

FIG. 6 is a partial top plan view of the fastening assembly of FIG. 1;

FIG. 7 is an exploded environmental view of the fastening assembly of FIG. 1;

FIG. 8 is a perspective environmental view of the fastening assembly of FIG. 1;

FIG. 9 is a cross sectional environmental view of the fastening assembly of FIG. 1;

FIG. 10 is another cross sectional environmental view of the fastening assembly of FIG. 1;

FIG. 11 is an exploded perspective view of the fastening assembly of FIG. 1, shown in conjunction with a complementary tool;

FIG. 12 is another exploded perspective view of the fastening assembly of FIG. 1, shown in conjunction with a complementary tool;

FIG. 13 is an exploded perspective view of a fastening assembly according to another preferred embodiment of the invention;

FIG. 14 is a partial top plan view of the fastening assembly of FIG. 12;

FIG. 15 is an exploded perspective view of the fastening assembly of FIG. 12, shown in conjunction with a complementary tool;

FIG. 16 is an exploded perspective view of a fastening assembly according to yet another preferred embodiment of the invention;

FIG. 17 is a partial top plan view of the fastening assembly of FIG. 15; and

FIG. 18 is a cross sectional environmental view of a fastening assembly according to the prior art.

### DESCRIPTION OF THE PREFERRED EMBODIMENT AND BEST MODE

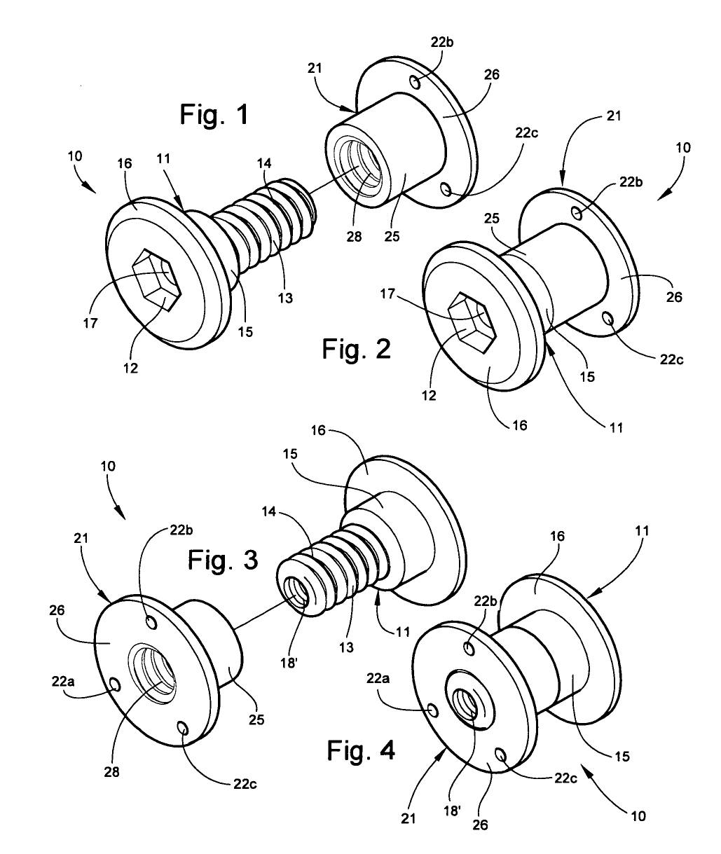

Referring now specifically to the drawings, a preferred embodiment of the fastening assembly according to the present invention is illustrated in FIG. 1, and shown generally at reference numeral 10. The fastening assembly 10 generally comprises a reducer bolt 11 for mating with a complementary female threaded element, such as receiving nut 21. The reducer bolt 11 and the receiving nut 21 are preferably cylindrical.

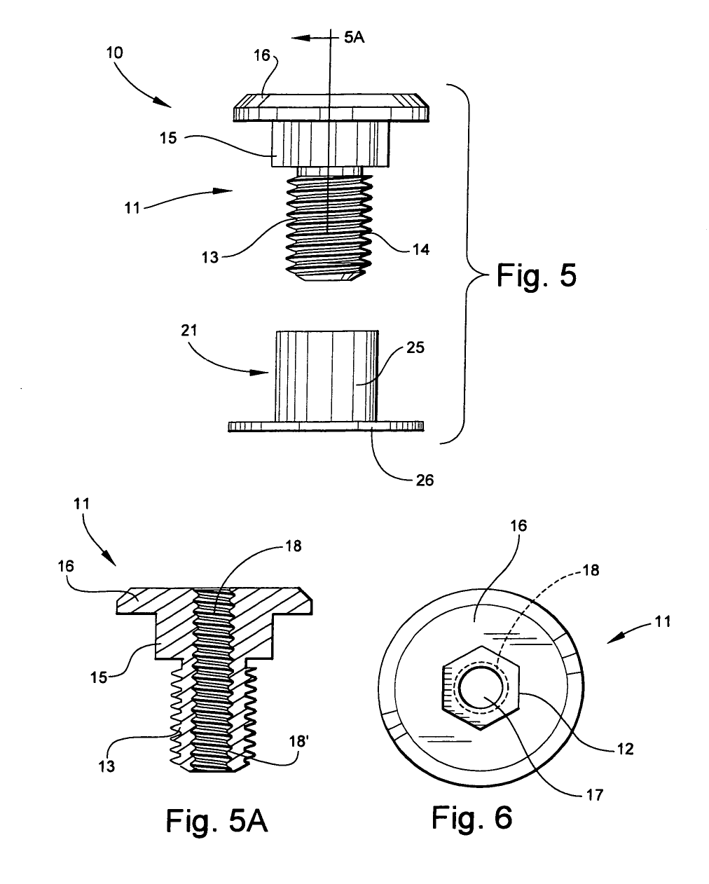

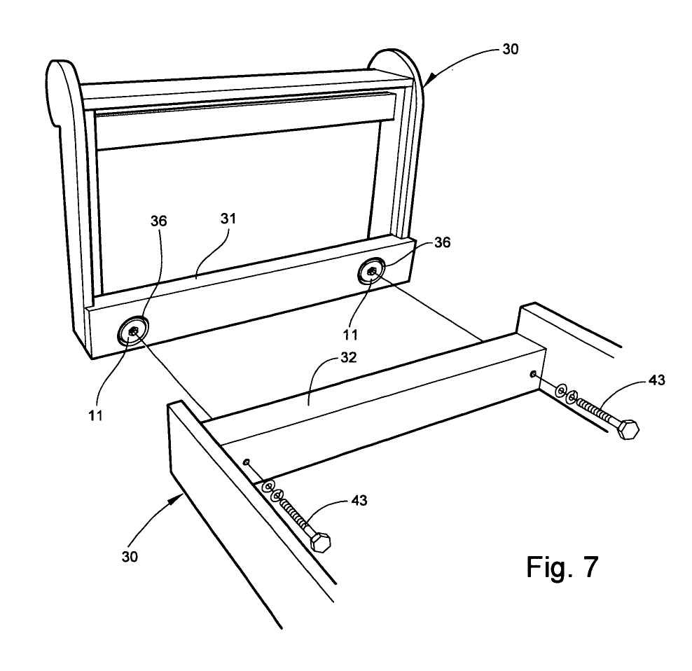

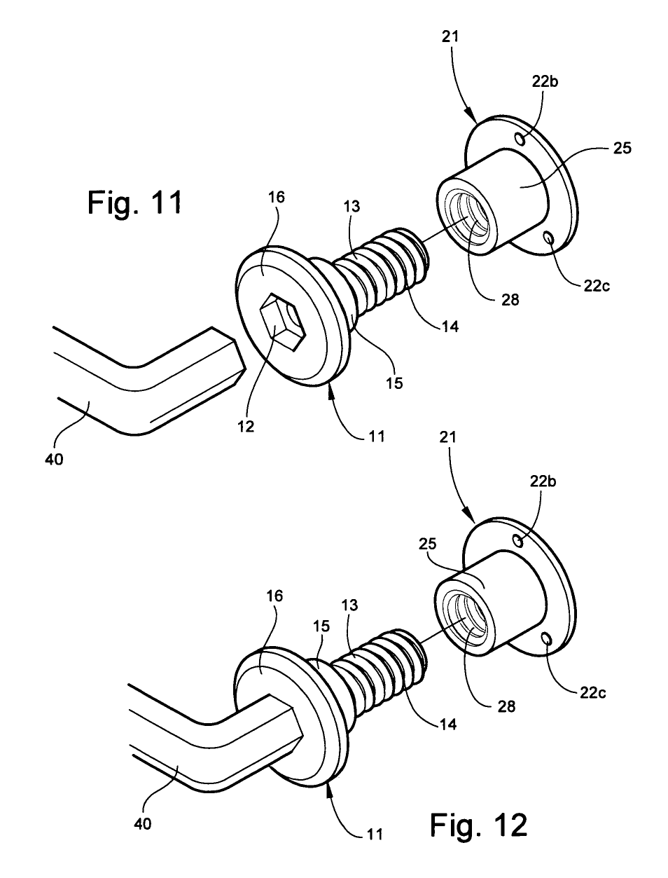

The reducer bolt 11 has a male section comprised of an elongate shank 13 having an exterior surface with threading 14. As shown in FIGS. 1-5, the reducer 11 has a stop collar 15 connected to the shank 13, and a head 16 connected to the opposite side of the collar 15. The collar 15 has a cylindrical female opening 17 with threading 18 along its interior surface, as shown in FIGS. 5A and 6. Preferably, the shank 13 is hollow and has an interior surface with threading 18′ that communicates with the threading 18 of the female opening 17 of the collar 15, as shown in FIG. 5A. The top surface of the head 16 has a centrally positioned aperture 12 that communicates with the opening 17 of the collar 15. The aperture 12 is hexagonal, and is larger than the diameter of the opening 17 of the collar 15. As such, the aperture 12 serves as an engagement mechanism by which the head 16 of the reducer bolt 11 can be engaged by a complementary tool, such as an Allen wrench 40, as shown in FIGS. 11 and 12.

As shown in FIGS. 1 and 3, the receiving nut 21 has a hollow body 25 connected to a cap 26. The body 25 has an interior female surface with threading 28. The cap 26 has three bores 22a-c formed proximate the outer edge of the cap 26, as shown in FIGS. 3 and 4.

The shank 13 has a diameter slightly less than the body 25 of the receiving nut 21 so that it can be inserted through an opening 27 in the body 25 of the receiving nut 21. The threading 14 of the shank 13 engages the threading 28 of the interior female surface of the nut 21. The length of the shank 13 is approximately equal to the length of the body 25 of the nut 21 so that the shank 13 can fit completely within the body 25. The body 25 of the nut 21 has a diameter that is approximately equal to the diameter of the collar 15 of the reducer bolt 11 so that the collar 15 contacts the body 25 in a substantially flush engagement, as shown in FIGS. 2 and 4, and prevents further insertion of the shank 13 into the nut 21.

Although the reducer bolt 11 is preferably used in conjunction with the receiving nut 21, as described above, the invention is not so limited. Any suitable female threaded element can be used in place of the receiving nut 21. For example, the reducer bolt 11 can be used in conjunction with a conventional T-nut with teeth.

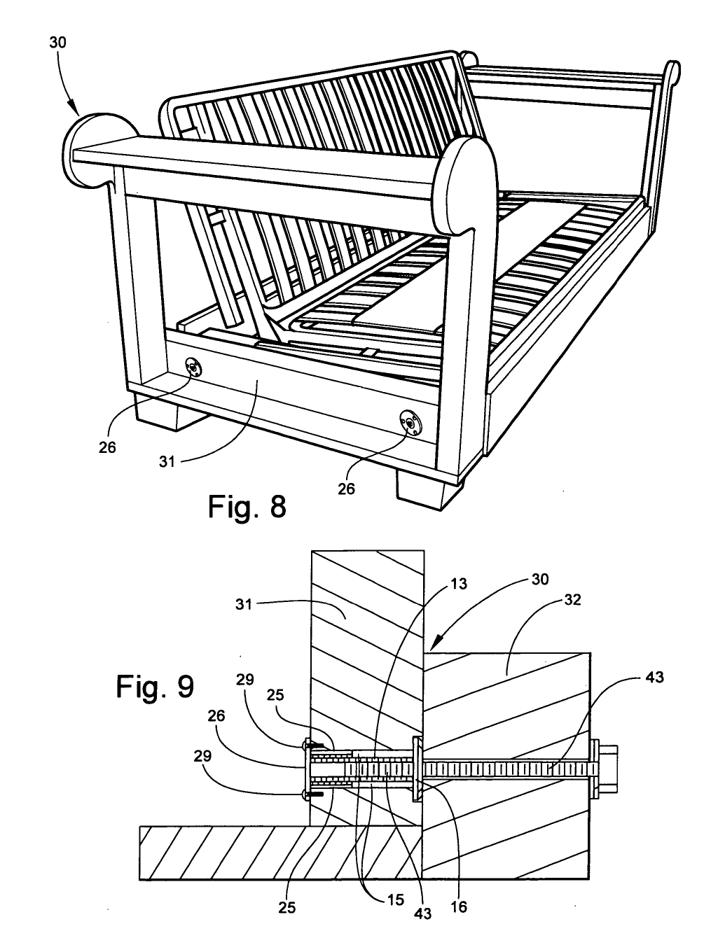

A preferred method of using the fastening assembly 10 is illustrated in FIGS. 7-9. The fastening assembly 10 is used to join two components 31, 32 in a knockdown furniture assembly 30. The furniture components 31, 32 are preferably made of wood, but can be made of a variety of materials. As shown in FIG. 9, the receiving nut 21 is positioned within a cavity in a first component 31 such that the body 25 is inside the component 31, and the cap 26 remains exposed on the outer surface of the component 31. Fasteners, such as screws 29, are positioned through the bores 22a-c of the cap 26 and into the component 31 to fasten the nut 21 to the component 31, as shown in FIGS. 8 and 9.

The reducer bolt 11 is positioned within a cavity on the opposite side of the first component 31. The reducer bolt 11 is positioned such that the shank 13 points toward the receiving nut 21. The component 31 has a countersunk section 36 in which the head 16 of the reducer bolt 11 sits substantially flush with the rest of the component 32, as shown in FIGS. 7 and 9.

The shank 13 is inserted into the body 25 of the receiving nut 21 until the stop collar 15 of the reducer bolt 11 contacts the outer edge of the body 25 of the nut 21. As such, the length of the collar 15 and the length of the body 25 determine the thickness of material that can be sandwiched between them. The threading 14 of the reducer bolt 11 engages the threading 28 of the receiving nut 21. The shank 13 is tightened against the nut 21 by turning the head 16 of the reducer bolt 11 by engaging the hexagonal aperture 12 with the Allen wrench 40, as shown in FIG. 12, and turning the head 16 in a clockwise direction. The reducer bolt 11 can be disengaged from the receiving nut 21 by turning the head 16 with the Allen wrench 40 counter-clockwise to release the engagement between the shank 13 and the nut 21.

As shown in FIGS. 7 and 9, the first component 31 is connected to the second component 32 by a complementary male threaded member, such as bolt 43, that is positioned through the second component 32, and inserted into the threaded female opening 17 of the reducer bolt 11. The threading of the bolt 43 engages the female threading 18, 18′ of the reducer bolt 11 to connect the second component 32 to the first component 31, as shown in FIG. 9. The bolt 43 is preferably one-half inch in diameter, and has number thirteen threading.

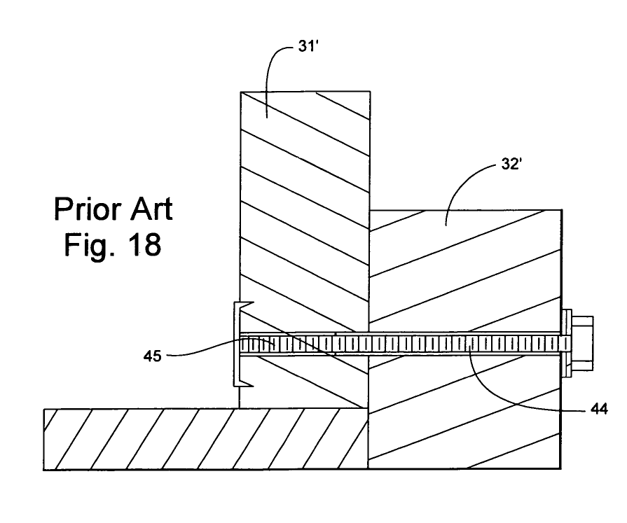

In the event the threading 18, 18′ of the reducer bolt 11 becomes worn out, the reducer bolt 11 can be removed from the furniture assembly 30 by removing the bolt 43, and releasing the reducer bolt 11 from the nut 21 by turning the head 16 of the reducer bolt 11 in a counter-clockwise direction with the Allen wrench 40. This provides a significant improvement over the prior art T-nut and bolt arrangement, shown in FIG. 18, in which furniture components 31′, 32′ are joined by a male threaded bolt 44 that is inserted into and engages a female threaded T-nut 45. In such an arrangement, the T-nut cannot be removed from component 31′ and replaced when its threading becomes worn.

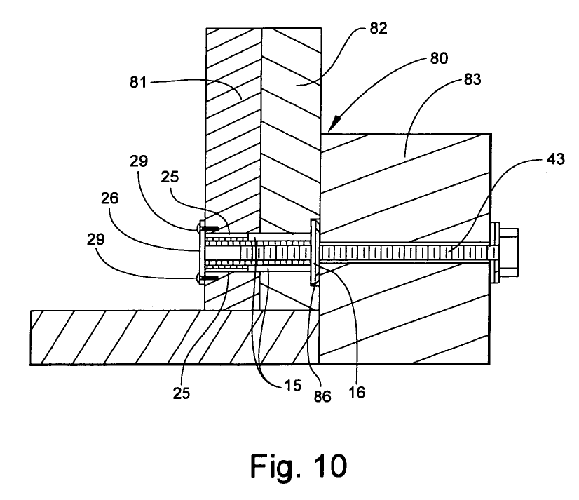

In another preferred embodiment illustrated in FIG. 10, the fastening assembly 10 is used to connect a furniture assembly 80 having three components 81, 82, 83. The receiving nut 21 is positioned within the first component 81, and the reducer bolt 11 is positioned within a cavity of the second component 82. The second component 82 has a countersunk section 86 in which the head 16 of the reducer bolt 11 sits substantially flush with the rest of the component 82, as shown in FIG. 10. The body 25 of the receiving nut 21 extends through the first component 81 and into a portion of the second component 82.

Engagement of the threading 14 of the shank 13 with the threading 28 of the receiving nut 21 connects the first component 81 and the second component 82 together. The reducer bolt 11 can be tightened against the receiving nut 21 by turning the head 16 with the Allen wrench 40 in a clockwise direction, as shown in FIG. 12. The components 81, 82 can be disconnected from each other by turning the head 16 with the Allen wrench 40 counter-clockwise to release the engagement between the shank 13 and the nut 21.

The first and second components 81, 82 are connected to the third component 83 by the complementary male threaded bolt 43 that is positioned through the third component 83, and inserted into the threaded female opening 17 of the reducer bolt 11. The threading of the bolt 43 engages the threading 18, 18′ of the reducer bolt 11 to connect the third component 83 to the second component 82, as shown in FIG. 10.

Although the fastening assembly 10 is described above as being preferably used in a knockdown furniture assembly 30, it is not limited to such an application, and can be used to connect any plurality of objects. The fastening assembly 10 can be used in a variety of applications, including, but not limited to, wall construction, joining steel components, and attaching a deck to a house or other structure.

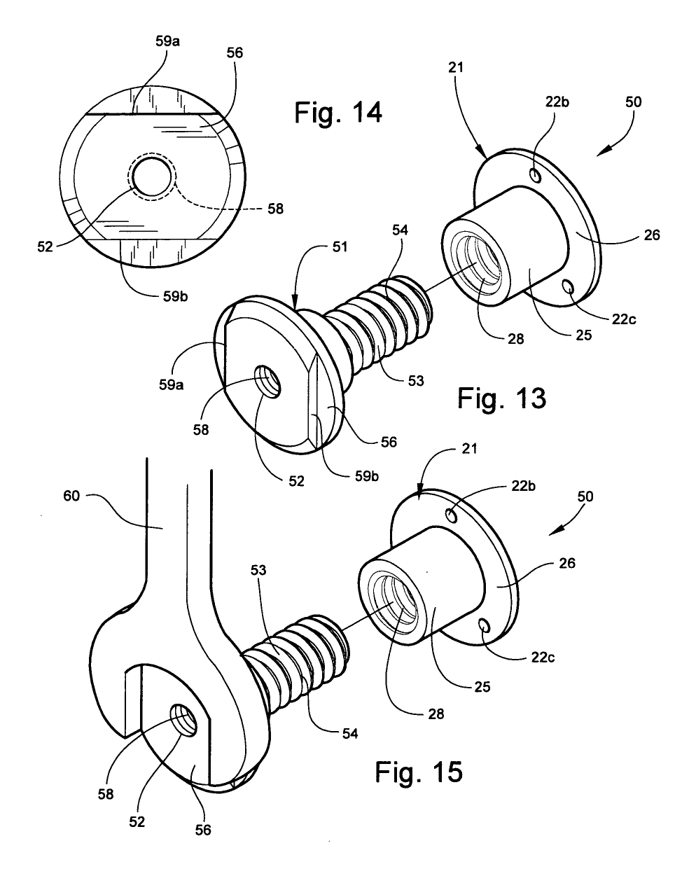

An alternative embodiment of the invention is illustrated in FIGS. 13-15, and shown generally at reference numeral 50. As in the fastening assembly 10 described above, the fastening assembly 50 includes a reducer bolt 51 with an outwardly extending shank 53 having an exterior surface with threading 54, and a stop collar 55 connected to the shank 53. A head 56 is connected to the opposite side of the collar 55. The collar 55 has a female opening with threading 58 along its interior surface. The top surface of the head 56 has a centrally positioned aperture 52 that communicates with the female opening of the collar 55. The fastening assembly 50 includes a receiving nut that is identical in structure to the receiving nut 21 described above, and therefore has identical reference numerals.

In the fastening assembly 50, the engagement mechanism on the head 56 of the reducer bolt 51 comprises wrench flats 59a, 59b, as shown in FIGS. 13 and 14. The wrench flats 59a, 59b can be engaged by a standard wrench 60, as shown in FIG. 15, to tighten the reducer bolt 51 against the receiving nut 21. The fastening assembly 50 is otherwise identical to the fastening assembly 10 described above, and can be used in the same manner as described above.

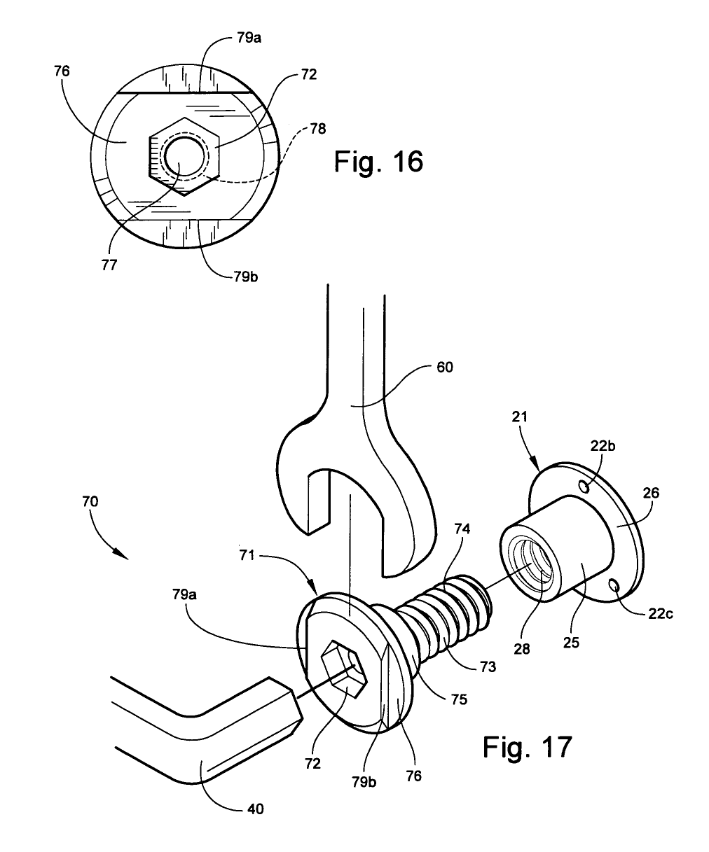

Another alternative embodiment is illustrated in FIGS. 16 and 17, and shown generally at reference numeral 70. As in the fastening assembly 10 described above, the fastening assembly 70 includes a reducer bolt 71 with an outwardly extending shank 73 having an exterior surface with threading 74, and a stop collar 75 connected to the shank 53. A head 76 is connected to the opposite side of the collar 75. The collar 75 has a female opening 77 with threading 78 along its interior surface. The top surface of the head 76 has a centrally positioned aperture 72 that communicates with the opening 77 of the collar 75. The fastening assembly 70 includes a receiving nut that is identical in structure to the receiving nut 21 described above, and therefore has identical reference numerals.

In the fastening assembly 70, the aperture 72 on the head 76 of the reducer bolt 71 has a hexagonal shape. In addition, the head 76 has wrench flats 79a, 79b. As such, the head 76 of the reducer bolt 71 can be engaged by both an Allen wrench 40 and a standard wrench 60, as shown in FIG. 16. The fastening assembly 70 is otherwise identical to the fastening assembly 10 described above, and can be used in the same manner as described above.

A fastening assembly and a method for using same are disclosed above. Various embodiments of the invention can be made without departing from its scope. Furthermore, the foregoing description of the preferred embodiment of the invention and the best mode for practicing the invention are provided for the purpose of illustration only and not for the purpose of limitation—the invention being defined by the claims.

1. A fastening apparatus comprising:
(a) an elongate threaded shank for being inserted into a complementary female threaded element;
(b) a collar concentrically provided on the shank, the collar defining a threaded female opening and having first and second ends, the first end proximate the shank and having a diameter greater than the shank for contacting the complementary female threaded element and preventing further insertion of the shank into the female threaded element;
(c) a head concentrically provided on the collar proximate the second end, the head having an aperture in communication with the collar opening for receiving a complementary male threaded member for mating with the threaded female opening of the collar; and
(d) wherein the head includes an engagement mechanism for receiving a tool whereby engagement between the shank and the complementary female threaded element is adjustable by turning the head with the complementary tool.

2. A fastening apparatus according to claim 1, wherein the engagement mechanism comprises a hexagonal indentation formed in the head, and the tool comprises an Allen wrench.

3. A fastening apparatus according to claim 1, wherein the engagement mechanism comprises wrench flats formed in the head, and the tool comprises a wrench.

4. A fastening apparatus according to claim 1, wherein the complementary female threaded element comprises a body defining a cavity having threads therein, and a cap having a diameter greater than the body.

5. A fastening apparatus according to claim 1, wherein the complementary female threaded element comprises a T-nut.

6. A fastening assembly for connecting a plurality of objects comprising:
(a) a first fastener comprising a body defining a cavity having threads therein; and
(b) a second fastener comprising:
(i) an elongate threaded shank adapted for being inserted into the cavity of the first fastener to engage the threads of the cavity therein,
(ii) a collar concentrically provided on the shank, the collar defining a threaded female opening and having first and second ends, the first end proximate the shank and having a diameter approximately equal to the body of the first fastener whereby the collar contacts the body of the first fastener and prevents further insertion of the shank into the cavity of the first fastener, and
(iii) a head concentrically provided on the collar proximate the second end, the head having an aperture in communication with the collar opening for receiving a complementary male threaded member for mating with the threaded female opening of the collar, and
(iv) wherein the head includes an engagement mechanism for receiving a tool whereby engagement between the first fastener and the second fastener is adjustable by turning the head of the second fastener with the tool.

7. A fastening assembly according to claim 6, wherein the engagement mechanism comprises a hexagonal indentation formed in the head, and the tool comprises an Allen wrench.

8. A fastening assembly according to claim 6, wherein the engagement mechanism comprises wrench flats formed in the head, and the tool comprises a wrench.

9. A fastening assembly according to claim 6, wherein the first fastener further comprises a cap having a diameter greater than the body and at least one bore therein.

10. A fastening assembly according to claim 6, wherein the first fastener and the second fastener are adapted for connecting components of a furniture piece.

11. A fastening assembly according to claim 6, wherein the second fastener is positioned within a first object, and the complementary male threaded member is positioned within a second object, whereby mating of the complementary male threaded member with the female threads of the second fastener connects the first and second objects.

12. A fastening assembly according to claim 11, wherein the first and second objects are components of a furniture piece.

13. A method for connecting a plurality of objects comprising the steps of:
(a) providing a first fastener comprising a body defining a cavity having threads therein;
(b) positioning the first fastener within a first object;
(c) providing a second fastener comprising:
(i) an elongate threaded shank adapted for being inserted into the cavity of the first fastener and mating with the threads therein,
(ii) a collar defining a threaded female opening, the collar carried concentrically on the shank and having first and second ends, the first end proximate the shank and having a diameter approximately equal to the body of the first fastener whereby the collar contacts the body and prevents further insertion of the shank into the cavity of the first fastener; and
(iii) a head carried concentrically on the collar proximate the second end and having an aperture in communication with the collar opening for receiving a complementary male threaded member for mating with the threaded female opening of the collar, and wherein the head includes an engagement mechanism for receiving a tool; and
(d) inserting the shank into the cavity of the first fastener to engage the threads therein, whereby the first fastener is connected to the second fastener.

14. The method of claim 13, further comprising the step of tightening the connection between the first fastener and the second fastener by turning the head of the second fastener clockwise with the tool.

15. The method of claim 14, further comprising the step of releasing the connection between the first fastener and the second fastener by turning the head of the second fastener counterclockwise with the tool.

16. The method of claim 13, further comprising the steps of:
(a) positioning the complementary male threaded member in a second object; and
(b) inserting the complementary male threaded member into the threaded female opening of the second fastener to engage the second fastener and connect the first and second objects.

17. The method of claim 13, wherein the step of positioning the first fastener within a first object comprises positioning the first fastener within a first component of a furniture piece.

18. The method of claim 17, wherein the step of positioning the complementary male threaded member within a second object comprises positioning the male threaded member within a second component of the furniture piece, whereby the first and second components of the furniture piece are connected.

19. The method of claim 13, further comprising the step of positioning the second fastener within a second object, whereby the first and second objects are connected by engagement of the first fastener and the second fastener.

20. The method of claim 19, further comprising the steps of:
(a) positioning the complementary male threaded member in a third object; and
(b) inserting the complementary male threaded member into the threaded female opening of the second fastener to engage the second fastener and connect the second and third objects.

21. A fastening apparatus according to claim 1, wherein the aperture in the head has a hexagonal shape having an area greater than an area defined by the threaded female opening of the collar whereby an Allen wrench can engage the head aperture.

22. A fastening apparatus according to claim 6, wherein the aperture in the head has a hexagonal shape having an area greater than an area defined by the threaded female opening of the collar whereby an Allen wrench can engage the head aperture.

23. A fastening apparatus according to claim 6, wherein the first fastener comprises a T-nut.
